(19) United States
(12) Patent Application Publication
(10) Pub. No.: US 2013/0181692 A1
(43) Pub. Date: Jul. 18, 2013

(54) POWER SUPPLY SYSTEM

(71) Applicants: Tien-Lung LEE, HSINCHU (TW); Jong-Hann JEAN, HSINCHU (TW); Chia-Hong CHEN, HSINCHU (TW)

(72) Inventors: Tien-Lung LEE, HSINCHU (TW); Jong-Hann JEAN, HSINCHU (TW); Chia-Hong CHEN, HSINCHU (TW)

(73) Assignee: RITEK CORPORATION, HSINCHU (TW)

(21) Appl. No.: 13/348,651

(22) Filed: Jan. 12, 2012

(51) Int. Cl. G05F 1/46

(52) U.S. Cl. 323/271

(57) ABSTRACT

A power supply system for supplying a power to a device is disclosed. The power supply system includes a solar cell and a regulator coupled with the solar cell. The solar cell receives and converts sunlight into an output voltage. The regulator converts the output voltage into a desired voltage level to be supplied to the device. The regulator is a DC-DC converter.

### BACKGROUND

1. Field of Invention

The present invention relates to a power supply system, and more particularly to a solar cell power supply system.

2. Description of Related Art

Electronic devices which are widely used as necessities or commodities in today, such as cellular phones, MP3 players, MD players, notebook computers, portable radios, digital cameras, and camcorders, are supplied with power from storage batteries or dry batteries. However, these batteries have to be recharged or exchanged with new ones in a definite period of time. A user has to be able to access a power source or auxiliary power supply to recharge a storage battery, but he/she may not recharge the storage battery if he/she is located remote from a power source or has no charger in hand.

To solve such problems, portable solar cell electricity chargers have been developed to receive and convert sunlight into electrical energy. Solar cells are characterized by a maximum Open Circuit Voltage (Voc) at zero output current and a Short Circuit Current (Isc) at zero output voltage, since power can be computed via this equation:

P=I*V

However, if the required charging voltage by electronic devices is larger than the Open Circuit Voltage (Voc) of solar cell electricity chargers; or the solar cell electricity chargers are hidden from light by cloud or the like to cause the Open Circuit Voltage (Voc) to be below the optimal system voltage, these Electronic devices cannot be charged by the solar cell electricity chargers.

Therefore, a solar cell electricity charger that can provide charging voltage is needed.

### SUMMARY

An object of the present invention is to provide a solar cell power supply system with a regulator used for stabling an output voltage.

The present invention provides a power supply system for supplying power to a device is disclosed. The power supply system includes a solar cell and a regulator coupled with the solar cell. The solar cell receives and converts sunlight into an output voltage. The regulator converts the output voltage into a desired voltage level being supplied to the device.

In an embodiment, the regulator is a DC-DC converter.

In an embodiment, the regulator is a DC-DC boost converter.

In an embodiment, the device is a portable device. The portable device is a cellular phone, a MP3 player, a MD player, a notebook computer, a portable radio or a digital camera.

The present invention provides a power supply system for supplying power to a device is disclosed. The power supply system includes a solar cell and a DC-DC converter coupled with the solar cell. The solar cell receives and converts sunlight into an output voltage. The DC-DC converter converts the output voltage into a desired voltage level to be supplied to the device.

The present invention utilizes a regulator to convert the direct current (DC) power produced by the solar cell into a desired voltage level to be supplied to a portable device. Therefore, a stable voltage can be supplied to the portable device even though the solar cell is hidden from light.

### BRIEF DESCRIPTION OF THE DRAWINGS

In order to make the foregoing as well as other aspects, features, advantages, and embodiments of the present invention more apparent, the accompanying drawings are described as follows:

FIG. 1 illustrates a power supply system of the present invention.

FIG. 2 is a circuit diagram of a regulator according to an embodiment.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

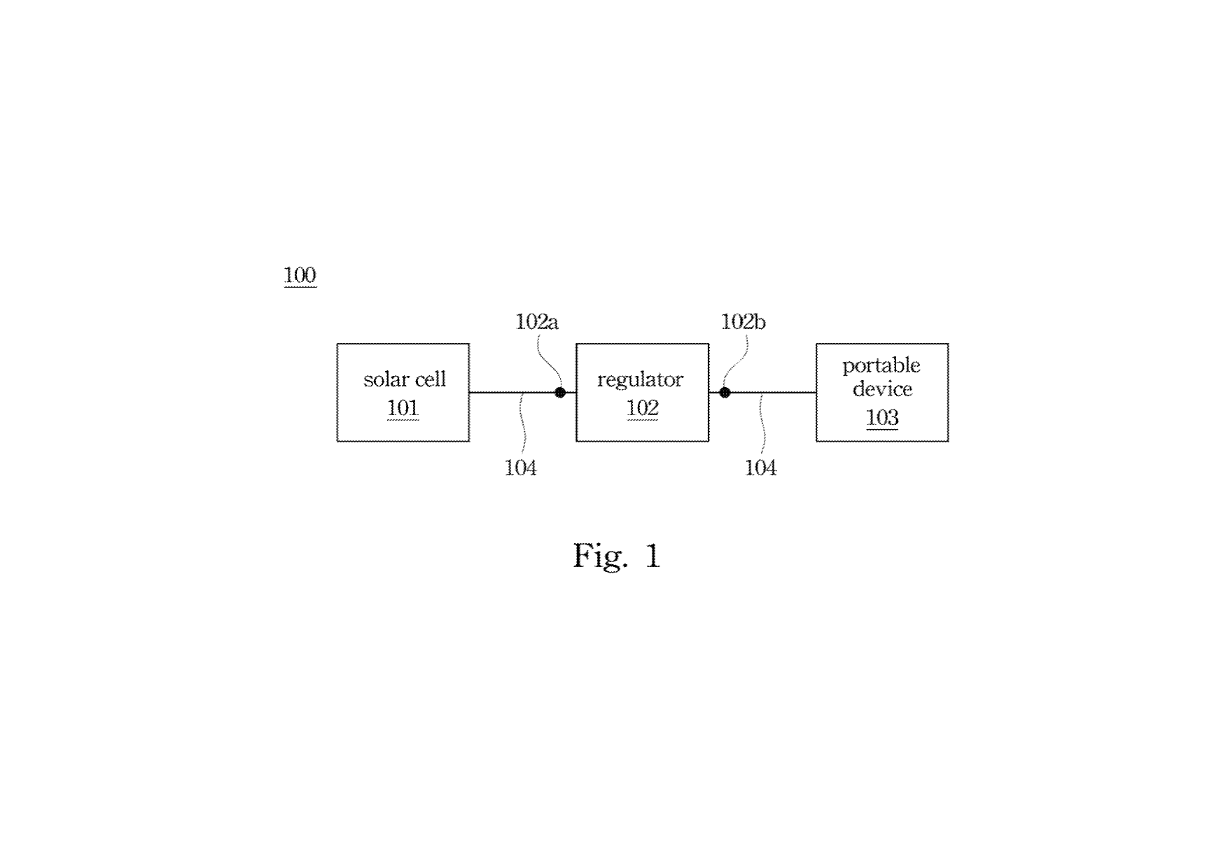

FIG. 1 illustrates a power supply system of the present invention. The power supply system 100 includes a solar cell 101, a regulator 102 and a portable device 103. The solar cell 101 produces an output voltage that is transmitted by a power cable 104. The voltage regulator 102 converts the output voltage of the solar cell 101 into a desired voltage level to be supplied to the portable device 103. The portable device is, such as, a cellular phone, a MP3 player, a MD player, a notebook computer, a portable radio or a digital camera.

Currently, various solar cells have been designed for receiving and converting sunlight into electrical energy. In an embodiment, the solar cell 101 has a P-type semiconductor layer and an N-type semiconductor layer. When sunlight projects on surfaces of the P-type semiconductor layer or the N-type semiconductor layer, a portion of the sunlight is unavoidably reflected by the surfaces, and the other portion thereof is absorbed. Photons in the absorbed sunlight collide with electrons in the P-type semiconductor layer or the N-type semiconductor layer, thereby generating electron-hole pair, and thus an electric field is formed between the P-type semiconductor layer and the N-type semiconductor layer, i.e., a photon-electron conversion is performed. That is, the solar cell 101 converts solar energy into direct current electricity via the photovoltaic effect. The output power from the solar cell is supplied to the regulator 102.

The regulator 102 is an inverter used to convert the direct current (DC) power produced by the solar cell 101 into a desired voltage level to be supplied to a portable device. The regulator 102 has a voltage input terminal 102a and a voltage output terminal 102b. The voltage input terminal 102a is connected to the solar cell 101, and the voltage output terminal 102b is connected to the portable device 103. In use, the solar cell 102 can supply power through converter 170 to the portable device 103. Therefore, even though the solar cell 102 is hidden from light, a stable voltage still can be supplied to the portable device 103. In an embodiment, the regulator 102 is a DC-DC converter. It should be noted that the single regulator 102 is connected to the solar cell 101. However, in one or more embodiments, a plurality of regulators can be connected to the solar cell 101 for providing different voltage levels.

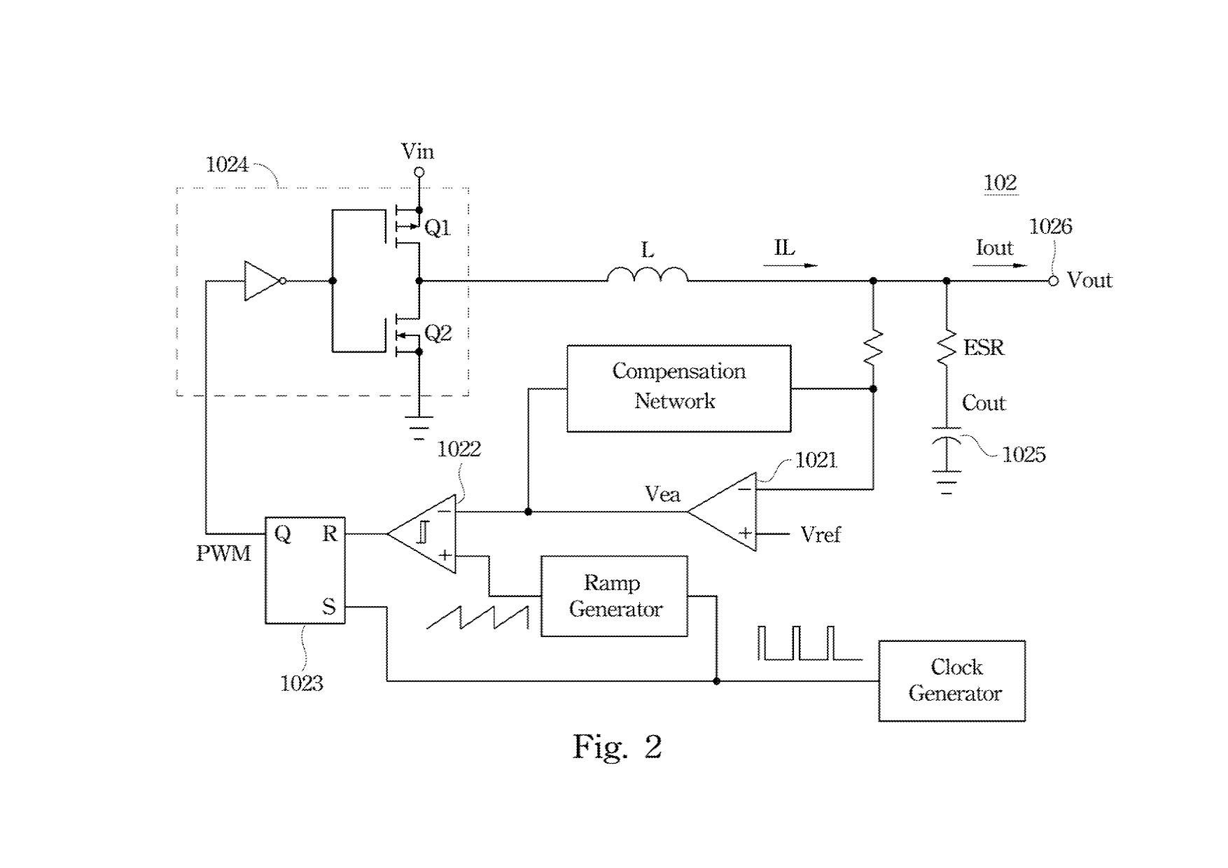

FIG. 2 is a circuit diagram of a regulator according to an embodiment. The regulator 102 includes a control loop that contains an error amplifier 1021, a comparator 1022 and an SR flip-flop 1023. The output voltage (Vout) is compared with a reference voltage (Vref) at the inputs of the error amplifier 1021. The comparator 1022 receives the output (Vea) of error amplifier 1021 as its first input and receives a saw-tooth or a triangle signal (Vramp) as its second input. The comparator's output is a PWM signal that is provided for SR flip-flop 1023 to drive an switch circuit 1024 containing a p-channel power switch Q1 and a n-channel power switch Q2 to supply a stable voltage to the to portable device 103. It is noted that other types of DC-DC converter, such as a DC-DC boost converter, can also be used in the present invention.

Accordingly, the present invention utilizes a regulator to convert the direct current (DC) power produced by the solar cell into a desired voltage level to be supplied to a portable device. Therefore, a stable voltage can be supplied to the portable device even though the solar cell is hidden from light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A power supply system for supplying power to a device, comprising:
a solar cell for receiving and converting sunlight into an output voltage; and
a regulator coupled with the solar cell for converting the output voltage into a desired voltage level to be supplied to the device.

2. The power supply system of claim 1, wherein the regulator is a DC to DC converter.

3. The power supply system of claim 1, wherein the regulator is a DC-DC boost converter.

4. The power supply system of claim 1, wherein the device is a portable device.

5. The power supply system of claim 4, the portable device is a cellular phone, a MP3 player, a MD player, a notebook computer, a portable radio or a digital camera.

6. A power supply system for supplying power to a device, comprising:
a solar cell for receiving and converting sunlight into an output voltage; and
a DC-DC converter coupled with the solar cell for converting the output voltage into a desired voltage level to be supplied to the device.

7. The power supply system of claim 1, wherein the DC-DC converter is a DC-DC boost converter.

8. The power supply system of claim 1, wherein the device is a portable device.

9. The power supply system of claim 4, the portable device is a cellular phone, a MP3 player, a MD player, a notebook computer, a portable radio or a in digital camera.
